(19) United States
(12) Patent Application Publication
(10) Pub. No.: US 2008/0128001 A1
(43) Pub. Date: Jun. 5, 2008

(54) Washing control apparatus and method of dish washing machine

(75) Inventors: Shimotera Kennichi, Seoul (KR); Bong Jin Park, Suwon-si (KR); Jang Woo Lee, Suwon-si (KR); Sang Soo Choi, Suwon-si (KR); Jung Chan Ryu, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/898,208

(22) Filed: Sep. 10, 2007

(30) Foreign Application Priority Data
Dec. 5, 2006 (KR) 10-2006-0122309

(51) Int. Cl. B08B 7/04

(52) U.S. Cl. 134/18; 134/56 D

(57) ABSTRACT

A washing control apparatus and method of a dish washing machine capable of determining a course selection in each operation through the detection of the turbidity of wash water at a preceding operation. The washing control method includes determining whether an automatic washing course has been selected according to a command of a user, when the automatic washing course has been selected, detecting a turbidity of wash water during washing, and selecting a course of a next operation based on the detected turbidity of the wash water.

### CROSS-REFERENCE TO RELATED APPLICATIONS

This application claims the benefit of Korean Patent Application No. 10-2006-0122309, filed on Dec. 5, 2006 in the Korean Intellectual Property Office, the disclosure of which is incorporated herein by reference.

### BACKGROUND

1. Field

The present invention relates to washing control of a dish washing machine. More particularly, to a washing control apparatus and method of a dish washing machine capable of determining a course selection in each operation through the detection of the turbidity of wash water at the preceding operation.

2. Description of the Related Art

A conventional dish washing machine is a machine that washes food leftovers (hereinafter, referred to as “contaminants”) off dishes using cold wash water or hot wash water. The dish washing machine includes a machine body having a washing tub, dish baskets mounted in the washing tub, injection nozzles to inject wash water to dish baskets, and a sump connected to the injection nozzles to pump wash water into the injection nozzles.

When wash water is introduced into the dish washing machine while dishes to be washed are placed in the dish baskets, the dish washing machine washes the dishes through washing and rinsing operations in which a washing pump mounted at the sump is operated to forward wash water to the injection nozzles and the wash water is injected to dishes through the injection nozzles at high pressure. The washing and rinsing operations include a preliminary operation (i.e., preliminary washing or preliminary rinsing) and a main operation (i.e., main washing or final rinsing). The preliminary operation may be performed a predetermined number of times (normally, two or three times) before the main operation.

Although the dishes can be completely washed by performing the preliminary operation (preliminary washing or preliminary rinsing) only once when the dishes are not excessively contaminated, however, the dish washing machine unconditionally performs the preliminary operation (i.e., preliminary washing or preliminary rinsing) a predetermined number of times. As a result, water consumption increases, and power consumption also increases.

### SUMMARY

Accordingly, it is an aspect of the invention to provide a washing control apparatus and method of a dish washing machine capable of determining a course selection in each operation through the detection of the turbidity of wash water at the preceding operation, thereby reducing the number of washing times and thus preventing waste of wash water.

It is another aspect of the invention to provide a washing control apparatus and method of a dish washing machine capable of accomplishing an appropriate washing process irrespective of kinds or degree of contamination through the detection of the turbidity of wash water at each operation, thereby appropriately controlling washing time while reliably performing washing.

Additional aspects and/or advantages will be set forth in part in the description which follows and, in part, will be apparent from the description, or may be learned by practice of the invention.

These and/or other aspects, of the present invention are achieved by providing a washing control method of a dish washing machine including determining whether an automatic washing course has been selected according to a command of a user, when the automatic washing course has been selected, detecting a turbidity of wash water during washing, and selecting a course of a next operation based on the detected turbidity of the wash water.

According to an aspect of the present invention, detecting the turbidity of the wash water includes detecting a turbidity of wash water during a preliminary washing operation or a rinsing operation of the dish washing machine.

According to an aspect of the present invention, selecting the course of the next operation includes comparing the detected turbidity of the wash water with a predetermined reference turbidity, and when the detected turbidity of the wash water does not exceed the predetermined reference turbidity, terminating an operation in progress and selecting a course of a next operation.

According to an aspect of the present invention, selecting the course of the next operation further includes, when the detected turbidity of the wash water exceeds the predetermined reference turbidity, performing continuously the operation in progress, and counting a number of performance times of the operation in progress, and, when the counted number of performance times exceeds a predetermined maximum number of performance times, terminating an operation in progress and selecting a course of a next operation.

According to an aspect of the present invention, the washing control method further includes operating the dish washing machine according to the selected course of the next operation to determine an operation course of the dish washing machine, and displaying the determined operation course of the dish washing machine.

According to an aspect of the present invention, the washing control method further includes determining whether to perform a drying operation based on the determined operation course of the dish washing machine.

According to an aspect of the present invention, when the operation course of the dish washing machine is a shortest time operation course, the drying operation is not performed, and, when the operation course of the dish washing machine is a longest time operation course or a normal operation course, the drying operation is performed.

It is another aspect of the present invention to provide a washing control apparatus of a dish washing machine including an input unit to select an automatic washing course according to a command of a user, a turbidity detection unit to detect a turbidity of wash water during washing when the automatic washing course is selected, and a control unit to select a course of a next operation based on the detected turbidity of the wash water.

According to an aspect of the present invention, the turbidity detection unit detects a turbidity of wash water during a preliminary washing operation or a rinsing operation of the dish washing machine.

According to an aspect of the present invention, the control unit compares the detected turbidity of the wash water with a predetermined reference turbidity, and, when the detected turbidity of the wash water does not exceed the predetermined reference turbidity, terminates an operation in progress and selects a course of a next operation.

According to an aspect of the present invention, when the detected turbidity of the wash water exceeds the predetermined reference turbidity, the control unit performs continuously an operation in progress and counting a number of performance times of the operation in progress, and, when the counted number of performance times exceeds a predetermined maximum number of performance times, terminates the operation in progress and selects a course of a next operation.

According to an aspect of the present invention, the control unit operates the dish washing machine according to the selected course of the next operation to determine an operation course of the dish washing machine and determines whether to perform a drying operation based on the determined operation course of the dish washing machine.

According to an aspect of the present invention, the washing control apparatus further includes a display unit to display the operation course of the dish washing machine determined by the control unit.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a side sectional view illustrating the structure of a dish washing machine according to an embodiment of the present invention;

FIG. 2 is a control block diagram of a dish washing machine according to an embodiment of the present invention; and

FIGS. 3A and 3B are flow charts illustrating a washing control method of a dish washing machine according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to like elements throughout. The embodiments are described below to explain the present invention by referring to the figures.

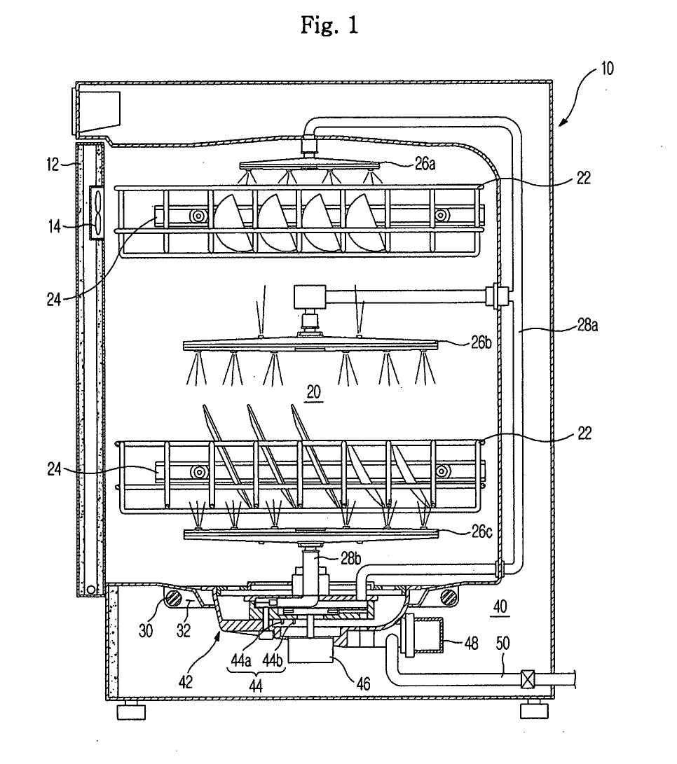

FIG. 1 is a side sectional view illustrating the structure of a dish washing machine according to an embodiment of the present invention.

As shown in FIG. 1, the dish washing machine comprises a machine body 10 having a washing space defined therein and a door 12 to open and close the front part of the machine body 10. The machine body 10 and the door 12 constitute the appearance of the dish washing machine. At one side of the door is mounted a drying fan 14 to dry dishes which have been washed.

In the machine body 10 is mounted a washing tub 20, in which a plurality of dish baskets 22 to receive dishes, racks 24 to slidably support the dish baskets 22, and an upper injection nozzle 26a, a middle injection nozzle 26b, and a lower injection nozzle 26c are mounted. Specifically, the upper injection nozzle 26a, the middle injection nozzle 26b, and the lower injection nozzle 26c are mounted above and below the dish baskets 22 to inject wash water.

The upper injection nozzle 26a and the middle injection nozzle 26b are connected with a sump 42, which will be described below, via a first supply pipe 28a. The lower injection nozzle 26c is connected to the sump 42 via a second supply pipe 28b.

At the bottom of the washing tub 20 is mounted a heater 30 to heat wash water. Specifically, the heater 30 is disposed in a heater receiving groove 32 formed at the bottom of the washing tub 20.

A machine compartment 40 is also mounted at the bottom of the washing tub 20, in which the sump 42, which pumps wash water introduced into the washing water 20 to forward the wash water to the upper, middle, and lower injection nozzles 26a, 26b, and 26c, is mounted. A turbidity sensor 44 is mounted in the sump 42, to detect the turbidity of water used to wash the dishes, i.e., the contamination level of wash water, during a washing operation.

The turbidity sensor 44 detects the turbidity of wash water using a photo coupler sensing light emitted from a light emitting part 44a, transmitted through wash water used to wash the dishes, and received by a light receiving part 44b.

The sump 42 comprises various flow channels. At the sump 42 is also mounted a washing pump 46 to pump water to the flow channels. At one side of the sump 42 are mounted a drainage pump 48 and a drainage pipe 50 to drain contaminated wash water to the outside.

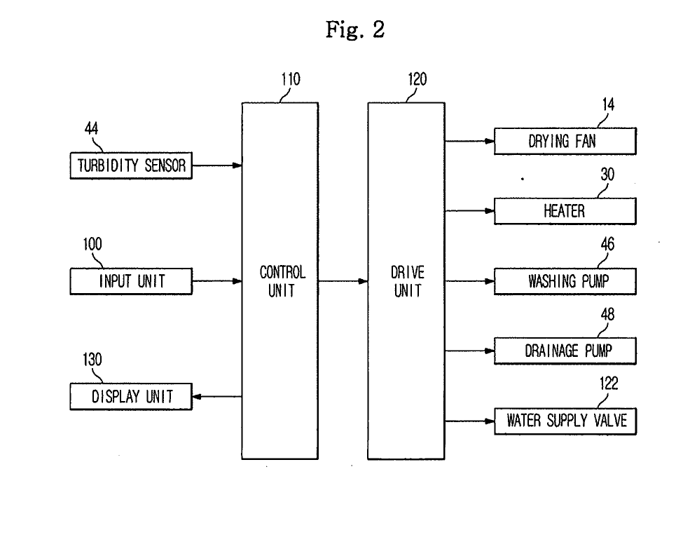

FIG. 2 is a control block diagram of a dish washing machine according to an embodiment of the present invention. In addition to the components shown in FIG. 1, the dish washing machine further comprises an input unit 100, a control unit 110, a drive unit 120, and a display unit 130.

The input unit 100 allows a user to input operation information such as various washing courses, a wash water temperature, and addition of rinsing to the control unit 110.

The washing courses comprise a standard washing course in which processes of each operation having a water supply operation to supply wash water, a washing operation to inject the wash water to dishes after the water supply, a heating operation to heat the wash water into hot water suitable for washing and rinsing to before the wash water is injected to the dishes, a drainage operation to drain the wash water to the outside after the washing, and a drying operation to dry the dishes which have been washed after the washing are sequentially performed, a manual washing course in which each operation is arbitrarily selected and performed by a user according to circumstances, and an automatic washing course in which a course selection in each operation is determined through the detection of the turbidity of wash water at the preceding operation.

The control unit 110 is a microcomputer that controls washing, rinsing, and drying operations of the dish washing machine according to the operation information inputted from the input unit 100. Specifically, the control unit 110 determines a course selection of each operation (a preliminary washing operation, a rinsing operation, etc.) through the detection of the turbidity of wash water at the preceding operation to decide a number of processing times for a washing operation (specifically, a preliminary washing) or a rinsing operation (specifically, a preliminary rinsing) and whether to process a drying operation, thereby reconstructing washing course operations from the shortest time washing course operation to the longest time washing course operation in the automatic washing course.

The drive unit 120 drives the drying fan 14, the heater 30, the washing pump 46, the drainage pump 48, and a water supply valve 122 according to a drive control signal of the control unit 110. The water supply valve 122 controls the supply of wash water into the washing tub 20.

The display unit 130 displays the operation state and error of the dish washing machine according to a display control signal of the control unit 110. When the automatic washing course is selected, the display unit 130 displays washing courses (the shortest time washing course operation, a normal washing operation, and the longest time washing course operation) reconstructed by the control unit 110 and operation time.

Hereinafter, a washing control method of the dish washing machine with the above-stated construction will be described in detail.

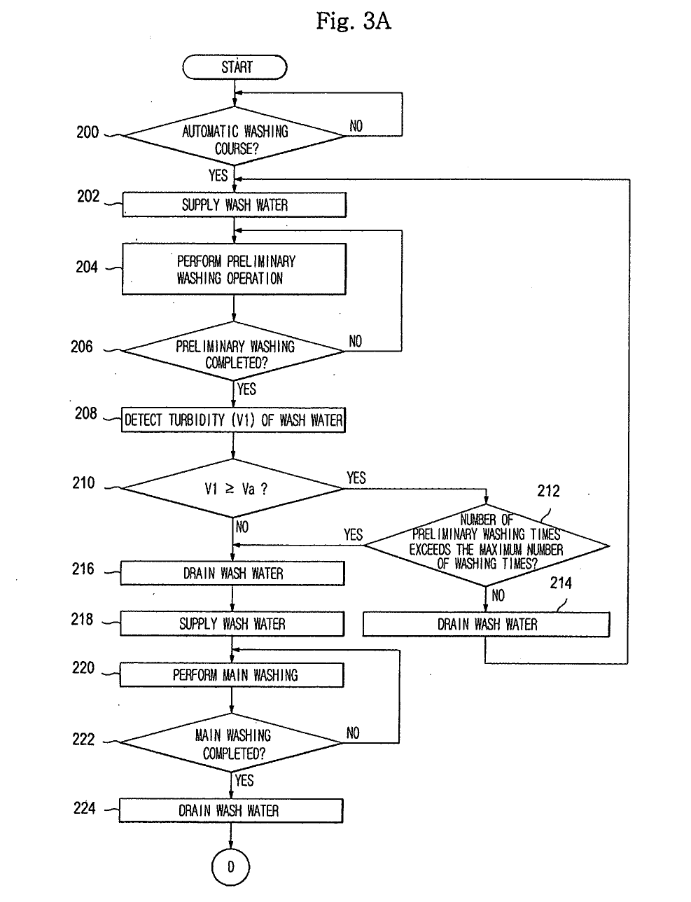

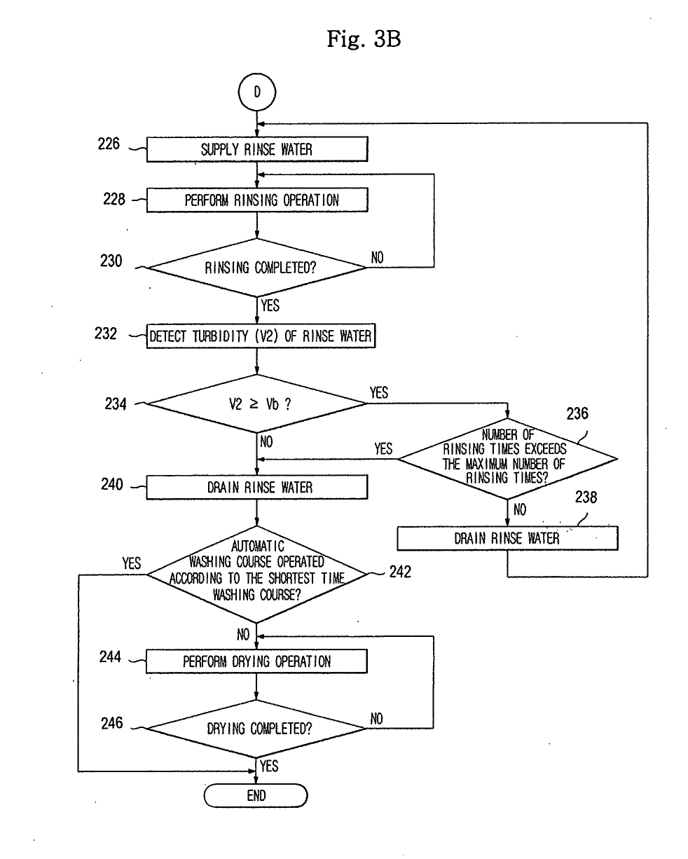

FIGS. 3A and 3B are flow charts illustrating a washing control method of the dish washing machine according to an embodiment of the present invention.

When a user selects operation information such as a washing course (for example, a smart automatic washing), wash water temperature, and addition of rinsing while dishes to be washed are placed in the dish baskets 22 mounted in the washing tub 20, the operation information selected by the user is inputted to the control unit 110 through the input unit 100.

The control unit 110 performs a series of washing operations such as a washing operation, a rinsing operation, and a drying operation according to the operation information inputted from the input unit 100. First, the control unit 110 determines whether the washing course selected by the user is an automatic washing course (operation 200).

When the washing course is the automatic washing course, the control unit 110 controls the water supply valve 122 through the drive unit 120. Consequently, wash water necessary for a preliminary washing is supplied into the washing tube 20 through wash water supply holes (not shown) (operation 202).

The wash water supplied into the washing tub 20 is introduced into the sump 42 mounted at the bottom of the washing tub 20. The introduced wash water is forwarded to the upper injection nozzle 26a, the middle injection nozzle 26b, and the lower injection nozzle 26c through the first and second supply pipes 28a and 28b by the pumping action of the washing pump 46 mounted at the sump 42, and a preliminary washing operation is performed to inject the wash water to the dishes placed in the dish baskets 22 at high pressure such that contaminants are removed from the dishes (operation 204).

As the preliminary washing progresses, the control unit 110 counts the progress time of the preliminary washing to determine whether a predetermined preliminary washing time (approximately 2 to 3 minutes) has elapsed, i.e., the preliminary washing has been completed (operation 206). When the preliminary washing has not been completed, the preliminary washing operation is performed continuously until the preliminary washing time elapses.

When it is determined that the preliminary washing has been completed, which means that the wash water and contaminants washed off the dishes by the wash water have been introduced into the sump 42, the turbidity sensor 44 mounted in the sump 42 senses light emitted from the light emitting part 44a, transmitted through the wash water used to wash the dishes, and received by the light receiving part 44b using the photo coupler to detect the turbidity V1 of the wash water used to wash the dishes during the preliminary washing before the drainage of the wash water (operation 208).

The control unit 110 compares the turbidity V1 of the wash water detected by the turbidity sensor 44 with a predetermined reference turbidity (the turbidity of wash water to determine whether to progress the preliminary washing) Va (operation 210). When the detected turbidity V1 of the wash water exceeds the predetermined reference turbidity Va, the control unit 110 determines that the contamination of the wash water is excessive, and determines whether a number of preliminary washing times performed by this time exceeds a predetermined maximum number of washing times (i.e., approximately three times) to further perform the preliminary washing (operation 212).

When the number of preliminary washing times does not exceed the maximum number of washing times, the control unit 110 drains the wash water containing the contaminants through the drainage pipe 50 according to the operation of the drainage pump 48 (operation 214). After that, the process returns to operation 202 to further perform the preliminary washing, i.e., to perform continuously a series of preliminary washing processes including supply of wash water, injection of the wash water, and drainage of the wash water.

When it is determined that the number of preliminary washing times exceeds the maximum number of washing times, the control unit 110 drains the wash water containing the contaminants through the drainage pipe 50 according to the operation of the drainage pump 48 (operation 216) and terminates the preliminary washing.

When it is determined at operation 210 that the detected turbidity V1 of the wash water does not exceed the predetermined reference turbidity Va, on the other hand, the control unit 110 determines that the contamination of the wash water is not excessive. Consequently, the control unit 110 drains the wash water containing the contaminants through the drainage pipe 50 according to the operation of the drainage pump 48 (operation 216) and terminates the preliminary washing.

After that, the control unit 110 controls the water supply valve 122 to supply wash water necessary for a main washing such that the main washing is performed after the preliminary washing (operation 218).

As in the preliminary washing, the wash water supplied into the washing tub 20 is introduced into the sump 42. The introduced wash water is forwarded to the upper injection nozzle 26a, the middle injection nozzle 26b, and the lower injection nozzle 26c by the pumping action of the washing pump 46, and a main washing operation is performed to inject the wash water to the dishes placed in the dish baskets 22 at high pressure (operation 220).

The main washing operation is an operation in which detergent is introduced into the wash water through a detergent introduction unit (not shown), while the wash water is heated to a predetermined temperature (approximately 55 to 65° C.) by the heater 30, before the washing water is injected at high pressure by the pumping action of the washing pump 46 such that hot wash water containing the detergent is injected to the dishes placed in the dish baskets 22 to wash the dishes.

As the main washing progresses, the control unit 110 counts the progress time of the main washing to determine whether a predetermined main washing time (i.e., approximately 20 minutes) has elapsed, i.e., the main washing has been completed (operation 222). When the main washing has not been completed, the main washing operation is performed continuously until the main washing time elapses.

When it is determined that the main washing has been completed, the control unit 110 drains the wash water used to wash the dishes according to the operation of the drainage pump 48 (operation 224), and controls the water supply valve 122 to supply rinse water necessary for rinsing such that the rinsing is performed after the main washing (operation 226).

As in the preliminary washing or the main washing, the rinse water supplied into the washing tub 20 is introduced into the sump 42. The introduced rinse water is forwarded to the upper injection nozzle 26a, the middle injection nozzle 26b, and the lower injection nozzle 26c by the pumping action of the washing pump 46, and a rinsing operation is performed to inject the rinse water to the dishes placed in the dish baskets 22 at high pressure such that the detergent is removed from the dishes (operation 228).

As the rinsing progresses, the control unit 110 counts the progress time of the rinsing to determine whether a predetermined rinsing time has elapsed, i.e., the rinsing has been completed (operation 230). When the rinsing has not been completed, the rinsing operation is performed continuously until the rinsing time elapses.

When it is determined that the rinsing has been completed, which means that the rinse water and the detergent removed from the dishes by the rinse water have been introduced into the sump 42, the turbidity sensor 44 detects the turbidity V2 of the rinse water used to rinse the dishes during the rinsing before the drainage of the rinse water (operation 248).

The control unit 110 compares the turbidity V2 of the rinse water detected by the turbidity sensor 44 with a predetermined reference turbidity (the turbidity of rinse water to determine whether to progress the rinsing) Vb (operation 234). When the detected turbidity V2 of the rinse water exceeds the predetermined reference turbidity Vb, the control unit 110 determines that the contamination of the rinse water is excessive, and determines whether a number of rinsing times performed by this time exceeds a predetermined maximum number of rinsing times (i.e., approximately three times) to further perform the rinsing (operation 236).

When the number of rinsing times does not exceed the maximum number of rinsing times, the control unit 110 drains the rinse water containing the detergent through the drainage pipe 50 according to the operation of the drainage pump 48 (operation 238). After that, the process returns to operation 226 to further perform the rinsing, i.e., to perform continuously a series of rinsing processes including supply of rinse water, injection of the rinse water, and drainage of the rinse water.

When it is determined that the number of rinsing times exceeds the maximum number of rinsing times, the control unit 110 drains the rinse water containing the detergent through the drainage pipe 50 according to the operation of the drainage pump 48 (operation 240) and terminates the rinsing.

When it is determined at operation 234 that the detected turbidity V2 of the rinse water does not exceed the predetermined reference turbidity Vb, on the other hand, the control unit 110 determines that the contamination of the rinse water is not excessive. Consequently, the control unit 110 drains the rinse water containing the detergent through the drainage pipe 50 according to the operation of the drainage pump 48 (operation 240) and terminates the rinsing.

The rinsing operation includes a preliminary rinsing and a final rinsing. The final rinsing is an operation in which gloss detergent is introduced into the wash water through a detergent introduction unit (not shown), while the wash water is heated to a predetermined temperature (i.e., approximately 73 to 75° C.) by the heater 30, before the washing water is injected at high pressure by the pumping action of the washing pump 46 such that hot wash water containing the gloss detergent is injected to the dishes placed in the dish baskets 22. When the hot water containing the gloss detergent is injected to the dishes, the dishes are heated, and then the dishes are dried by latent heat. Consequently, the final rinsing provides a drying effect.

Subsequently, the control unit 110 determines whether the automatic washing course progressed by this time has been operated according to a predetermined shortest time washing course (i.e., a quick course including a one-time preliminary washing, a one-time main washing, and a two-time rinsing) to determine whether to perform a drying operation after the rinsing (operation 242). When the automatic washing course has been operated according to the predetermined shortest time washing course, the control unit 110 terminates all the operations.

When it is determined that the automatic washing course has not been operated according to the predetermined shortest time washing course, i.e., the automatic washing course has been operated according to a predetermined longest time washing course (a heavy course including a three-time preliminary washing, a one-time main washing, and a three-time rinsing) or a normal washing course (a course including a two-time preliminary washing, a one-time main washing, and a three-time rinsing, the control unit 110 performs a drying operation in which the drying fan 14 is operated to dry the dishes (operation 244).

As the drying progresses, the control unit 110 counts the progress time of the drying to determine whether a predetermined drying time (i.e., approximately 20 minutes) has elapsed, i.e., the drying has been completed (operation 246). When the drying has not been completed, the drying operation is performed continuously until the drying time elapses.

When it is determined that the drying has been completed, the control unit 110 terminates all the operations.

While the automatic washing course is performed, on the other hand, the control unit 110 and controls the display unit 130 to display the progress state and time of the shortest time washing course (i.e., the quick course), the normal washing course, and the longest time washing course (i.e., the heavy course) reconstructed by determining a course selection in each operation (i.e., the preliminary washing operation, the rinsing operation, etc.) through the detection of the turbidity of the wash water at the preceding operation such that the user easily recognizes the state of the current course of the dish washing machine.

As apparent from the above description, the washing control apparatus and method of the dish washing machine according to embodiments of the present invention have the effect of determining a course selection in each operation through the detection of the turbidity of wash water at the preceding operation, thereby reducing the number of washing times and thus preventing waste of wash water.

Furthermore, the washing control apparatus and method of the dish washing machine according to embodiments of the present invention have the effect of accomplishing an appropriate washing process irrespective of kinds or degree of contamination through the detection of the turbidity of wash water at each operation, thereby appropriately controlling washing time while reliably performing washing.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A washing control method of a dish washing machine, comprising:
determining whether an automatic washing course has been selected according to a user command;
detecting a turbidity of wash water during washing when the automatic washing course has been selected; and
selecting a course of a next operation based on the detected turbidity of the wash water.

2. The washing control method according to claim 1, wherein detecting the turbidity of the wash water comprises:
detecting a turbidity of wash water during a preliminary washing operation or a rinsing operation of the dish washing machine.

3. The washing control method according to claim 1, wherein selecting the course of the next operation comprises:
comparing the detected turbidity of the wash water with a predetermined reference turbidity, and, terminating the operation in progress and selecting a course of a next operation when the detected turbidity of the wash water does not exceed the predetermined reference turbidity.

4. The washing control method according to claim 3, wherein selecting the course of the next operation further comprises:
performing continuously the operation in progress when the detected turbidity of the wash water exceeds the predetermined reference turbidity, and
counting a number of performance times of the operation in progress, and, when the counted number of performance times exceeds a predetermined maximum number of performance times, terminating an operation in progress and selecting a course of a next operation.

5. The washing control method according to claim 1, further comprising:
operating the dish washing machine according to the selected course of the next operation to determine an operation course of the dish washing machine; and
displaying the determined operation course of the dish washing machine.

6. The washing control method according to claim 5, further comprising:
determining whether to perform a drying operation based on the determined operation course of the dish washing machine.

7. The washing control method according to claim 6, wherein, when the operation course of the dish washing machine is a shortest time operation course, the drying operation is not performed.

8. The washing control method according to claim 6, wherein, when the operation course of the dish washing machine is a longest time operation course or a normal operation course, the drying operation is performed.

9. A washing control apparatus of a dish washing machine, comprising:
an input unit to select an automatic washing course according to a user command;
a turbidity detection unit to detect a turbidity of wash water during washing when the automatic washing course is selected; and
a control unit to select a course of a next operation based on the detected turbidity of the wash water.

10. The washing control apparatus according to claim 9, wherein the turbidity detection unit detects a turbidity of wash water during a preliminary washing operation or a rinsing operation of the dish washing machine.

11. The washing control apparatus according to claim 9, wherein the control unit compares the detected turbidity of the wash water with a predetermined reference turbidity, and, terminates the operation in progress and selects a course of a next operation when the detected turbidity of the wash water does not exceed the predetermined reference turbidity.

12. The washing control apparatus according to claim 11, wherein, the control unit performs continuously the operation in progress and counting a number of performance times of the operation in progress when the detected turbidity of the wash water exceeds the predetermined reference turbidity, and, terminates the operation in progress and selects a course of a next operation when the counted number of performance times exceeds a predetermined maximum number of performance times.

13. The washing control apparatus according to claim 9, wherein the control unit operates the dish washing machine according to the selected course of the next operation to determine an operation course of the dish washing machine and determines whether to perform a drying operation based on the determined operation course of the dish washing machine.

14. The washing control apparatus according to claim 13, further comprising:
a display unit to display the operation course of the dish washing machine determined by the control unit.

15. A control method of a dish washing machine, the method comprising:
determining a course selection in each operation of the dish washing machine through detection of a turbidity of wash water in the dish washing machine at a preceding operation.

16. A control method of a dish washing machine, the method comprising:
selecting operation information of the dish washing machine;
determining whether the selected operation information is an automatic washing course to be performed;
detecting a turbidity of wash water during washing, when the automatic washing course is selected; and
selecting a next operation to be performed, based upon the detected turbidity of the wash water.
